(19) United States
(12) Patent Application Publication
(10) Pub. No.: US 2016/0132878 A1
(43) Pub. Date: May 12, 2016

(54) Payment Card Including User Interface for Use with Payment Card Acceptance Terminal

(71) Applicant: VISA INTERNATIONAL SERVICE ASSOCIATION, San Francisco, CA (US)

(72) Inventors: Alan Joseph O'Regan, Cape Town (ZA); Horatio Nelson Huxham, Cape Town (ZA); Tara Anne Moss, Cape Town (ZA); Hough Arie Van Wyk, Cape Town (ZA)

(21) Appl. No.: 14/898,859

(22) PCT Filed: Jun. 30, 2014
(86) PCT No.: PCT/IB2014/062734

§ 371 Date: Dec. 16, 2015

(30) Foreign Application Priority Data
Jul. 2, 2013 (ZA) 2013/04916

(51) Int. Cl. G06Q 20/40; G06Q 20/34

(52) U.S. Cl. CPC G06Q 20/401; G06Q 20/34; G06Q 2220/00

(57) ABSTRACT

A payment card, for use with a payment card acceptance terminal, and related systems and methods are disclosed. The payment card includes an acceptance terminal interface component for interfacing with a payment card acceptance terminal and a user input receiving component for receiving an input by a user directly. The payment card also includes an integrated circuit which is in communication with the acceptance terminal interface and the user input receiving component and is configured to provide payment credentials to the payment card acceptance terminal on receipt of an input at the user input receiving component.

### CROSS-REFERENCES TO RELATED APPLICATIONS

This application claims priority to and incorporates by reference South African Provisional Patent Application No. 2013/04916 filed on 2 Jul. 2013.

### FIELD OF THE INVENTION

The field of the invention relates to payment cards which include a user interface for use with payment card acceptance terminals.

### BACKGROUND

Point-of-sale devices for receiving payment from a customer may take various forms. Dedicated point-of-sale devices at established retailers may be portable or fixed and are generally designed to receive a standard form of payment card. The card reader of such point-of-sale devices may be, for example, an integrated chip reader, a magnetic stripe reader, or a Near Field Communication (NFC) reader.

Point-of-sale devices are evolving for more mobile merchants in which a computing device such as a personal computer, tablet, or smart phone is used with an auxiliary device for reading a payment card and securely encrypting payment details for transmittal. However, some auxiliary devices do not include a means of entering a Personal Identity Number (PIN) other than on the merchant's device. This may be problematic in terms of the Payment Card Industry Data Security Standards.

As another background aspect, tokens, typically being numeric or alpha-numeric sequences, may be presented to third-parties by users so as to transfer payment or account information in the way of trade or commerce. Such tokens may present problems for redeeming a token via point-of-sale devices.

For example, a user may receive a token, representing an amount of currency, which he or she may present to a third-party, being a merchant, so as to enact a payment for goods received from or services received by that merchant. In another example, a mobile money token may be issued by a mobile money operator upon request by a user. The user may then present this token to a participating merchant or to a participating mobile money agent so as to redeem the token. Similarly, a user may request and subsequently communicate a token to a third party, being a friend or family member, as a remittance medium. This friend or family member may then redeem the token at a participating merchant or to a participating mobile money agent so as to redeem the token.

Oftentimes, tokens are closed-loop in that an issued token may only be redeemed at participating third-parties and may not be accepted by others. The closed-loop nature of such and other tokens is often necessitated by the fact that the tokens are often not easily formatted into conventional payment message formats and/or are not easily entered into conventional point-of-sale devices. For example, the token may not provide sufficient information to be formatted into a payment message which is communicated to a payment processing network. Furthermore, it may be difficult and expensive to modify each and every point-of-sale device for token acceptance.

In some cases, interoperability may be achieved by physically embodying the tokens on, or linking the tokens to, payment cards—often referred to as cash-cards—which provide necessary routing information and an appropriate point-of-sale device interface, However, such a solution places limitations on the ease of requesting and transferring tokens between parties and also raises costs.

These and other limitations with point-of-sale devices present problems as methods of payment develop.

### BRIEF SUMMARY

In accordance with a first aspect of the invention, there is provided a payment card for use with a payment card acceptance terminal, the payment card comprising: an acceptance terminal interface component for interfacing with a payment card acceptance terminal; a user input receiving component for receiving an input by a user directly; an integrated circuit in communication with the acceptance terminal interface and the user input receiving component and configured to provide payment credentials to the payment card acceptance terminal on receipt of an input at the user input receiving component.

A further feature provides for the integrated circuit to be configured to provide payment credentials stored on the payment card on receipt of an input in the form of a passcode at the user input receiving component.

A yet further feature provides for the integrated circuit to be configured to provide payment credentials in the form of a single use account number received as an input at the user input receiving component.

A still further feature provides for the integrated circuit to be configured to provide payment credentials formatted by the integrated circuit by transforming an input in the form of a token received at the user input receiving component into the payment credentials.

Further features provide for the integrated circuit to be configured to decode the token and to appropriately format information contained therein into payment credentials, and for the information contained in the decoded token to include an account number.

A still further feature provides for the information contained in the decoded token to include an account number, a card verification value (CVV) or similar, and an expiration date.

Yet further features provide for the integrated circuit to be configured to include a bank identification number in the payment credentials, and for the bank identification number to be retrieved from a digital memory of the integrated circuit,

Further features provide for the payment credentials to represent track two or track two equivalent payment credentials; for the payment credentials to include data elements of track 2 according to ISO/IEC 7813; and for the data elements to be selected from the group of: a primary account number, an expiration date, a service code, discretionary data and a card verification value.

Still further features provide for the integrated circuit to be configured to generate a card verification value, for generating a card verification value to encrypt at least one of received credential using an encryption key, and decimalize the result; and for the encryption key to be retrieved from a digital memory of the integrated circuit.

It is further provided for the integrated circuit to generate the OW by encrypting one or more of the PAN, expiration date and service code.

Further features provide for the payment credentials to be tag 57 or track two equivalent data; for the payment credentials to include data elements of track 2 according to ISO/IEC 7813; and for the data elements to include: the PAN, the expiration date, a service code, and optionally discretionary data and a CVV.

It is still further provided for the user input receiving component to be a keypad integrated into the payment card, and for the keypad to be an alpha-numeric keypad.

Still further features provide for the acceptance terminal interface component to be a contact-based interface insertable into a card slot of the acceptance terminal; and for the contact-based interface to include conductive contact pads for providing a contact based connection to corresponding conductive contacts of the card slot of the payment card acceptance terminal. The conductive contact pads may conform to the ISO/IEC 7816 specification.

Yet further features provide for the acceptance terminal interface component to be a wireless interface component for communicating wirelessly with the payment acceptance terminal; and for the wireless interface component to be an ISO/IEC 14443 wireless communication interface.

A further feature provides for the acceptance terminal interface component to be a magnetic stripe.

The user input receiving component may be configured to receive or harvest power from the card acceptance terminal.

Further features provide for the integrated circuit to be a secure crypto-processor configured to perform cryptographic functions and translation functions; for the secure crypto-processor to enable end-to-end secure communications between the user input receiving component and the acceptance terminal interface component.

Still further features provide for the integrated circuit to be a hardware security module comprising a public processor and a secure processor.

In accordance with a second aspect of the invention, there is provided a system for providing payment credentials, comprising: a payment card acceptance terminal having a card reading component; and a payment card for use with the payment card acceptance terminal including: an acceptance terminal interface component for interfacing with a payment card acceptance terminal; a user input receiving component for receiving an input by a user directly; an integrated circuit in communication with the acceptance terminal interface and the user input receiving component and configured to provide payment credentials to the payment card acceptance terminal on receipt of an input at the user input receiving component.

In accordance with a third aspect of the invention, there is provided a method carried out at an integrated circuit of a payment card comprising: receiving a user input, wherein the user input is directly received into the payment card; providing payment credentials to an acceptance terminal interface component based on the user input.

Further features provide for receiving a user input to receive a passcode and for providing payment credentials to release stored payment credentials from the payment card to the acceptance terminal interface component.

Still further features provide for receiving a user input to receive a single use account number and for providing payment credentials to provide the single use account number to the acceptance terminal interface component.

Yet further features provide for receiving a user input to receive a token and for providing payment credentials to transform the user input into formatted payment credentials.

In accordance with another aspect of the invention, there is provided a dual-interface adapter device for a payment card acceptance terminal, the dual-interface adapter device comprising: a contact-based interface insertable into a card slot of the acceptance terminal; a user interface, configured to receive power from the acceptance terminal via the contact-based interface and to receive input from a user; and, an integrated circuit, in communication with the contact-based interface and the user interface and configured to perform cryptographic functions and translation functions; wherein the user interface is configured to receive a token from the user, and the integrated circuit is configured to decode the received token and to appropriately format information contained therein into payment credentials so that a payment card acceptance terminal can process the payment credentials.

### BRIEF DESCRIPTION OF THE DRAWINGS

FIG. 1 is a schematic diagram which illustrates a system for providing payment credentials;

FIG. 2A is a schematic diagram of an exemplary system according to embodiments of the invention;

FIG. 2B is a schematic diagram of an exemplary system according to another embodiment;

FIG. 2C is a yet another schematic diagram of an exemplary system according to a further embodiment;

FIG. 3A is a block diagram which illustrates an exemplary dual-interface adapter device according to an embodiment of the invention;

FIG. 3B is a block diagram which illustrates an exemplary dual-interface adapter device according to another embodiment of the invention;

FIG. 4 is a swim-lane flow diagram which illustrates methods for providing payment credentials;

FIG. 5 is a block diagram which illustrates a system for providing payment credentials;

FIG. 6 illustrates an example of a computing device in which various aspects of the disclosure may be implemented; and,

FIG. 7 shows a block diagram of a communication device that may be used in embodiments of the disclosure.

### DETAILED DESCRIPTION

A payment card, for use with a payment card acceptance terminal, and related systems and methods are provided. The payment card is a dual-interface adaptor device in that it provides a user input receiving component for interfacing with a user and an acceptance terminal interface component for interfacing with a payment card acceptance terminal, The user input receiving component receives input by a user directly. The payment card also includes an integrated circuit in communication with the acceptance terminal interface and the user input receiving component and configured to provide payment credentials to the payment card acceptance terminal on receipt of an input at the user input receiving component,

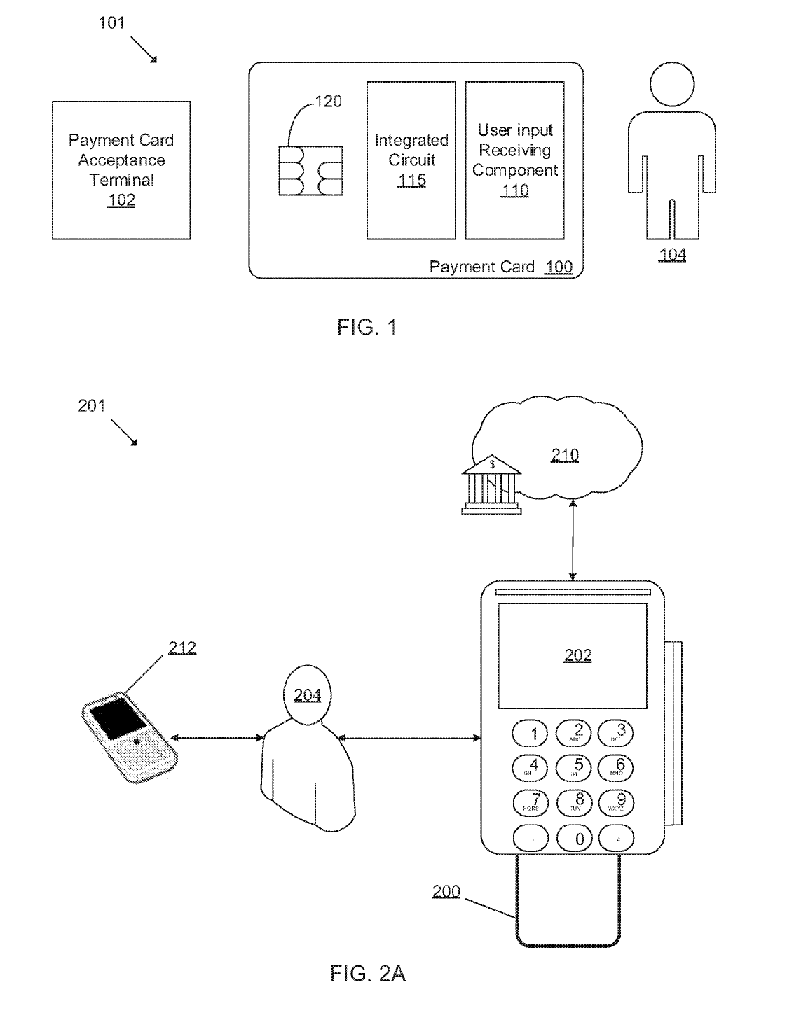

FIG. 1 is a schematic diagram which illustrates a system (101) for providing payment credentials. The system (101) includes a payment card acceptance terminal (102) and a payment card (100) for use with the payment card acceptance terminal (102).

The payment card acceptance terminal (102) may take on a variety of forms. The payment card acceptance terminal (102) may for example be a conventional point-of-sales device having an appropriate card reading component. The card reading component may for example be a contact-cased card reader, such as a magnetic stripe reader or an electrical contact reader, or an appropriate wireless interface such as, a Near Field Communication (NFC) interface. The point-of-sales device may be fixed or handheld. In other instances, the payment card acceptance terminal (102) may be a mobile communication device such as a mobile phone or tablet computer. Such a communication device may be capable of interfacing with the payment card (100) using a built-in card reading component or alternatively via an accessory device. Exemplary accessory devices include the Square™ accessory card reading device provided by Square, Inc.

The payment card (100) may physically resemble a conventional payment card such as a credit card. The payment card (100) includes an acceptance terminal interface component, which in the illustrated embodiment is a contact-based interface (120) providing a number of electrical contacts, for interfacing with the payment card acceptance terminal (102). In other embodiments, the acceptance terminal interface may be a magnetic stripe or a wireless interface component such as for example an NFC interface. The magnetic stripe may be a magnetic stripe emulator in that it may be configured to receive data from the integrated circuit of the payment card and to output the data over a medium which may be readable by a conventional magnetic stripe reader. The acceptance terminal interface component may include a combination of a contact-based interface, a magnetic stripe and a wireless interface component.

The payment card (100) also includes a user input receiving component (110) for receiving an input by a user (104) directly. Anticipated user input receiving components may also be referred to as user interfaces and may include touch sensitive input components such as keypads, keyboards and the like. The payment card (100) also includes an integrated circuit (115) in communication with the contact-based interface (120) and the user input receiving component (110). The integrated circuit (115) is configured to provide payment credentials to the payment card acceptance terminal (102) on receipt of an input from the user (104) at the user input receiving component (110).

In some embodiments, the integrated circuit (115) is configured to provide payment credentials stored on the payment card (100) to the payment card acceptance terminal (102) on receipt of an input in the form of a passcode at the user input receiving component (110).

In other embodiments, the integrated circuit (115) is configured to provide payment credentials in the form of a single use account number received as an input at the user input receiving component (110).

It is further provided that in other embodiments, the integrated circuit (115) is configured to provide payment credentials formatted by the integrated circuit by transforming an input in the form of a token received at the user input receiving component (110) into the payment credentials.

The integrated circuit (115) may include a number of integrated circuits and in some embodiments may embody a secure element. The integrated circuit (115) may be, for example, a secure crypto-processor configured to perform cryptographic functions and translation functions. In some embodiments, the secure crypto-processor may enable end-to-end secure communications between the user input receiving component and the acceptance terminal interface component. In some embodiments, the integrated circuit (115) may be a hardware security module comprising a public processor and a secure processor.

The description which follows provides further details of more specific embodiments of the payment card and associated systems and methods. It should be appreciated that aspects of the various embodiments described in this specification may, where applicable, be applied to other embodiments.

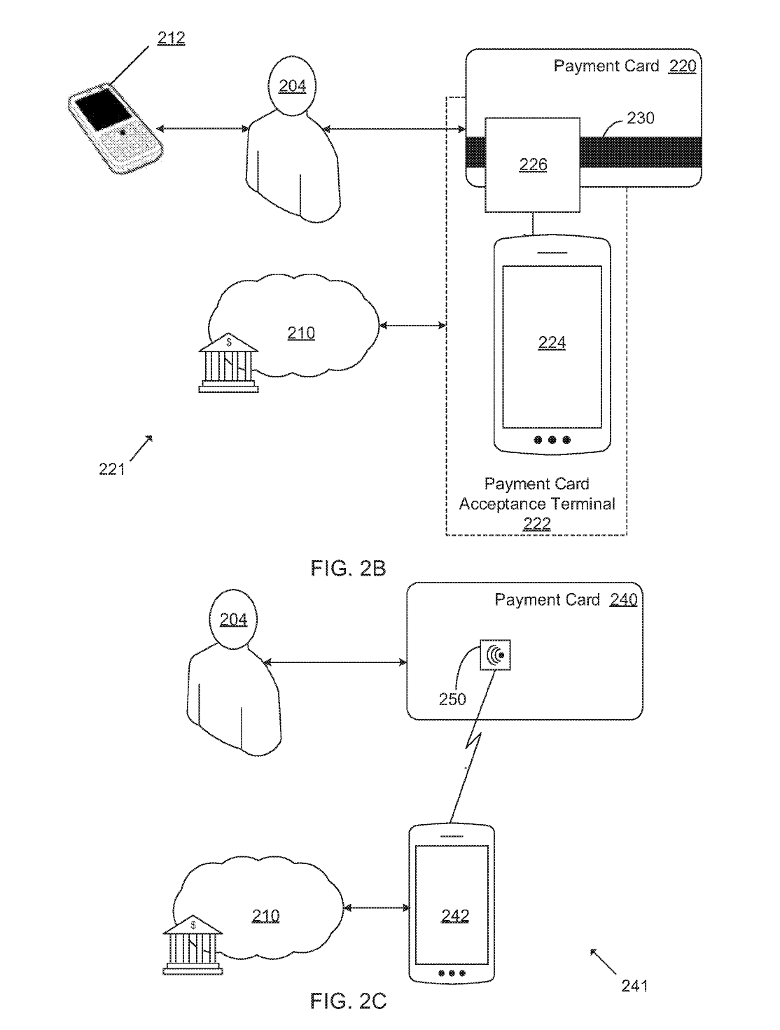

FIG. 2A illustrates a block diagram of a system (201) for providing payment credentials according to one embodiment. The system (201) includes a payment card (which may also be referred to as a dual-interface adaptor device) such as that described above with reference to FIG. 1. The payment card (200) may be capable of being inserted into a card acceptance terminal (202) which in this embodiment is a point-of-sale device. The card acceptance terminal (202) may be in communication with a payment processing network (210).

A mobile device (212) of a user (204) is also provided. The mobile device (212) may be a mobile phone and may be capable of receiving a payment token or single-use payment credentials. The payment token may be provided to the card acceptance terminal (202) by the user (204) using the payment card (200) so as to make a payment.

For example, the user may receive a payment token on his or her mobile device (212). The payment token may be received from a mobile money service provider to which the user (204) subscribes or alternatively it may be transmitted to the user (204) by a friend of the user (204) as a form of remittance. In any event, having received the token and wishing to redeem it, the user (204) may enter the token into a user input receiving component of the payment card (200). The payment card (200) may be configured to format the token into payment credentials being in accordance with, for example, EMV standards such that they may be communicated from the payment card (200) to the card acceptance terminal (202) without the card acceptance terminal (202) having to be modified. In response to receiving the payment credentials from the payment card (200), the card acceptance terminal (202) may then be operable to communicate the payment credentials to the payment processing network (210) for processing of the transaction as per existing practices, The payment processing network (210) may be any appropriate payment processing network and may include acquiring and issuing financial institutions and the like.

In another embodiment, the user (204) may receive single-use payment credentials (for example a primary account number (PAN) permitted for a single use only) on the user's mobile device (212). The user (204) may then input the single-use payment credentials into the payment card (200) using the user input receiving component. The payment card (200) may, in turn, be configured to transmit the single-use payment credentials received at the user input receiving component to the card acceptance terminal (202) for onward transmission to the payment processing network (210). In such an embodiment, it may not be necessary for the payment card (200) to format or decode the received single-use payment credentials. It should also be anticipated that the single-use payment credentials need not be single-use and may simply be payment credentials already in an acceptable form.

FIG. 2B is a block diagram of an exemplary system (221) for providing payment credentials according to another embodiment. The system (221) illustrated in FIG. 2B is similar to the system (201) illustrated in FIG. 2A and may include a payment processing network (210), a mobile device (212) of a user (204), a payment card (220) and a payment card acceptance terminal (222). In the embodiment illustrated in FIG. 2B, however, the payment card (220) provides an acceptance terminal interface component in the form of a magnetic stripe (230). The magnetic stripe (230) may be a magnetic stripe emulator. It should be appreciated, however, that the acceptance terminal interface component could be in the form of a contact-based interface or a wireless interface component.

Furthermore, the payment card acceptance terminal (222) is in the form of a mobile device (224) having an accessory device (226) connected thereto. The accessory device (226) may enable the mobile device (224) to interface with the payment card (220). In the illustrated embodiment, the accessory device (226) interfaces with the payment card (220) via a magnetic stripe (230) of the payment card while in other embodiments, the accessory device may be configured to interface with the payment card (220) via a contact-based interface or a wireless interface component. The accessory device (226) may, for example, enable the mobile device to receive payment credentials from the payment card (220).

For example, in some embodiments, payment credentials are stored on the payment card (220). However, before the payment credentials are provided to the payment card acceptance terminal (222), the user (204) will have to input a passcode into the payment card (220) using a user input receiving component of the payment card. In response to successfully entering the passcode into the payment card (220), the payment credentials stored therein may be provided to the payment card acceptance terminal (222). In the illustrated embodiment, the payment credentials are provided to the payment card acceptance terminal (222) via an acceptance terminal interface component being a magnetic stripe (230). In other embodiments, however, the payment credentials may be provided to the payment card acceptance terminal (222) via an acceptance terminal interface component being a contact-based interface or a wireless interface component. As such, embodiments provide for the payment card to function as a personal passcode (or PIN) entry device which may be advantageous in cases where a payment card acceptance terminal (222) does not have an appropriate user input component for the entry of a passcode or does not meet data security standards such as those proposed by PCI DSS.

In another exemplary use case of the system (221) illustrated in FIG, 2B, the user (204) may receive a payment token or single-use payment credentials on the user's mobile device (212). The user (204) may enter the token or payment credentials, as the case may be, into the payment card (220) using a user input receiving component of the payment card (220). The payment card (220) may then transmit the payment credentials (which may be either the token having been formatted into payment credentials or the received payment credentials), via the magnetic stripe (230), to the payment card acceptance terminal (222) for onward transmission to the payment processing network (210).

A schematic diagram of yet another embodiment of a system for providing payment credentials is illustrated in FIG. 20. This system (241) is similar to that of FIG. 2A as well as the system (221) of FIG, 2B. In this embodiment, the payment card acceptance terminal (242) is a mobile device of a merchant. The acceptance terminal interface component of the payment card (240) is a wireless communication interface (250). Thus, the payment card (240) may be able to transmit payment credentials to the payment card acceptance terminal (242) via a wireless communication channel. As has been described in the foregoing, the payment card (240) may be configured to receive user input via a user input receiving component and, in response to receiving the user input, transmit payment credentials to the payment card acceptance terminal (242). The user input may include one of single-use payment credentials, a payment token, a personal identification number (PIN) or the like. The payment card acceptance terminal (242) may then transmit the payment credentials received from the payment card (240) to the payment processing network (210).

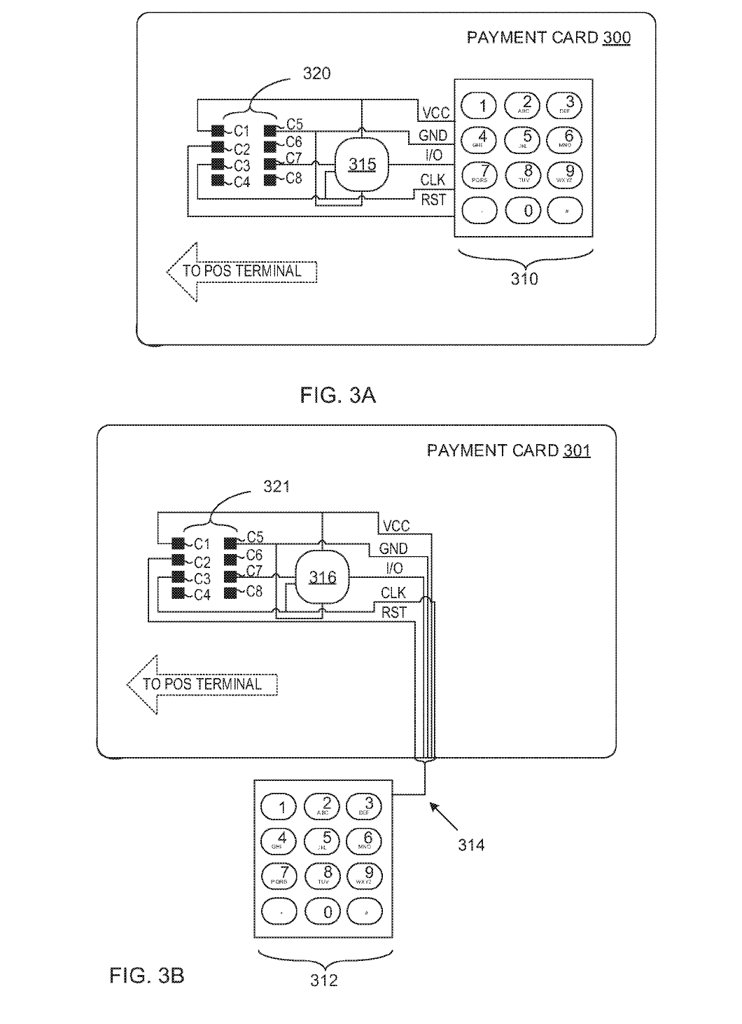

FIG. 3A is a schematic diagram of an exemplary payment card (300) according to some embodiments. The payment card (300) may have payment credentials stored therein or may be a dual-interface adapter device having no payment credentials stored therein. In this embodiment, the payment card (300) is in the form of a card. The size of the payment card (300) resembles the size of a credit card to allow the payment card (300) to be insertable into a payment card acceptance terminal. The payment card (300) includes an acceptance terminal interface component being a contact-based interface (320), a user input receiving component (310) being an alpha-numeric keypad, and an integrated circuit (315) being a secure element. The integrated circuit is in communication with the contact-based interface (320) and the user input receiving component (310).

The user input receiving component (310) may be any appropriate user interface, and in a preferred embodiment is an alpha-numeric keypad. Embodiments of the invention provide for the keypad to include a serial data (I/O) which performs any serialize and de-serialize functions as required, and translates data received at the user input receiving component (310) into character frames for communication to the integrated circuit (315). The data received at the user input receiving component (310) may, for example, be a token input by a user. In other embodiments, the user input receiving component (310) may be a QWERTY keypad.

In the exemplary embodiment, the contact-based interface (320) is compliant with the Europay-MasterCard-Visa (EMV) specification according to the ISO/IEC 7816 standard. The contact-based interface (320) provides eight conductive contact pads C1-C8 at specific dimensions and locations on the payment card (300) in accordance with the EMV specification. The contact-based interface (320) provides a physical contact-based connection between the payment card (300) and the payment card acceptance terminal when the payment card (300) is inserted into the card acceptance terminal. The contact-based interface (320) includes a C1 contact pad that is coupled to the VCC input of the user input receiving component (310) and the integrated circuit (315), a C2 contact pad that is coupled to the RST input of the user input receiving component (310), a C3 contact pad that is coupled to the CLK input of the of the user input receiving component (310) and the integrated circuit (315), a C5 contact pad that is coupled to the GND input of the user input receiving component (310) and the integrated circuit (315), and a C7 contact pad that is coupled to the serial data I/O of the user input receiving component (310) via the integrated circuit (315). In some embodiments, the contact pads C4, C6, and C8 are not used by the payment card (300), and hence these contact pads can be omitted from the contact-based interface (320) in these embodiments.

The payment card (300) includes an integrated circuit (315). In some embodiments, the integrated circuit (315) is configured to decode a token received at the user interface and to format information contained in the decoded token into payment credentials. The information contained in the decoded token may include an account number, an expiration date and optionally a card verification value (CVV), which may also be known as a card security code (CSC), card verification data (CVD), card verification value code (CVVC), card verification code (CVC or CVC2), verification code (V-code or V code), card code verification (CCV) or signature panel code (SPC).

The decoded information may be formatted into payment credentials such that the payment credentials can be processed by the payment card acceptance terminal. In preferred embodiments, the payment credentials, into which the token is formatted are track 2, or track 2 equivalent data (which may also referred to as tag 57 data). For example, the payment credentials may include data elements of track 2 according to ISO/IEC 7813. The data elements include a primary account number (PAN), a field separator (hex ‘D’), an expiration date, a service code, discretionary data (which may include a CVV), and are optionally padded with one hex ‘F’.

Some of the data elements of the track 2 payment credentials may be populated with decoded information obtained from the token, such as the expiration date, for example. The integrated circuit (315) may be further configured to annex a bank identification number (BIN) to the account number to form a PAN which populates the PAN data element. The BIN may be retrieved from a digital memory of the integrated circuit (315) and may provide necessary routing information. In preferred embodiments, the service code data element is populated with a service code retrieved from the digital memory of the integrated circuit (315). In some embodiments, the decoded information does not include a CVV, in which case the integrated circuit (315) is configured to generate the CVV by, for example, encrypting one or more of the PAN, expiration date and service code with an encryption key and decimalising the result. The encryption key may be retrieved from the digital memory of the integrated circuit (315) and may be specific to an issuer of the payment (300) and/or to that specific payment card.

The integrated circuit (315) may be further configured to perform auxiliary functions such as cryptographic functions (e.g., encryption, decryption) and translation functions to adapt the payment credentials into character frames to comply with the EMV specification if required. The integrated circuit (315) may receive power (VCC and GND) and a clock signal (CLK) from the C1, C5 and C3 contact pads respectively. The integrated circuit (315) may be any suitable circuit or microprocessor and in a preferred embodiment includes a secure crypto-processor. Such an embodiment accordingly provides for the integrated circuit to be in accordance with those provided in conventional ‘chip and pin’ or integrated circuit (IC) credit cards. This enables end-to-end secure communications between the user input receiving component (310) and the contact-based interface (320).

Further embodiments of the invention provide for the integrated circuit (315) to be a hardware security module (HSM) which uses hardware to encrypt and decrypt data instead of solely performing the encryption/decryption in software, and accordingly provides enhanced protection over software encryption technologies. For example, the HSM might be able to provide secure key management to generate cryptographic keys, sets the capabilities and security limits of keys, implement key backup and recovery, prepare keys for storage and performs key revocation and destruction. In some embodiments, the HSM is implemented as a dual processor device that includes a secure processor with storage and a public processor with storage. The two processors may each comprise one or more secure crypto-processors and may be identical to each other. Alternatively the secure processor may be implemented with one or more secure crypto-processors while the public processor may be implemented with one or more processors. The HSM may also include a physical or logical separation between interfaces that are used to communicate critical security parameters and other interfaces that are used to communicate other data. The HSM can also provide a tamper-proof mechanism that provides a high risk of destroying the HSM and the cryptographic keys stored therein, if any attempt is made to remove or externally access the HSM. The HSM according to embodiments of the invention may be compliant with at least a security level 2 of the FIPS 140-2 standard. Preferably, the HSM in embodiments of the invention is compliant with security level 3 or level 4 of FIPS 140-2. In some embodiments, the HSM is a packaged semiconductor chip that includes both a secure processing unit (SPU) and a public processing unit (PPU) in a single package, but with a logical and physical separation between the SPU and the PPU. In other embodiments, the SPU and the PPU can be individually packaged semiconductor chips or semiconductor dies that are coupled together to implement the HSM.

In some embodiments of the invention, the integrated circuit (315) may have payment credentials and a passcode offset stored therein. In such an embodiment, the payment credentials may only be provided to a payment card acceptance terminal upon receipt of an input in the form of a corresponding passcode at the user input receiving component (310). For example, a user wishing to provide payment credentials to a merchant so as to conduct a financial transaction, may be required to input a passcode into the payment card (300) using the user input receiving component (310). The received passcode may be transmitted from the user input receiving component (310) to the integrated circuit (315) whereupon it may be compared to the passcode offset stored therein. If the passcode matches the offset, the integrated circuit (315) may be configured to transmit the payment credentials to a payment card acceptance terminal via the contact-based interface (310). Such an embodiment may provide a payment card (300) which is configured to function as its own personal PIN entry device (PPED).

In other embodiments, single-use payment credentials may be input into the payment card (300) via the user input receiving component (310). The single-use payment credentials may be transmitted from the user input receiving component (310) to the integrated circuit (315). In some cases, the single-use payment credentials may be received in a format which is acceptable by a payment card acceptance terminal, in which case the integrated circuit (315) may transmit the received single-use payment credentials to the payment card acceptance terminal via the contact-based interface (320). In other cases, where the received single-use payment credentials are not in a format acceptable by the payment card acceptance terminal, the integrated circuit may format the received single-use payment credentials into a format which is acceptable to the payment card acceptance terminal.

FIG. 3B is a schematic diagram which illustrates an embodiment wherein the user input receiving component (312) of the payment card (301) or dual-interface adapter device is provided as a separate unit. The user interface (312) is in communication with the integrated circuit (316) via a cable (314). In other embodiments, the user interface (312) may be in wireless communication with the integrated circuit (316). Such embodiments may enable a user may hold the user interface (312) in his or her hand while entering a token.

Embodiments of the invention accordingly provide a payment card which may be compatible with any conventional card acceptance terminal, for example an EMV card acceptance terminal specified according to ISO/IEC 7816 standards, without any modifications having to be performed on that card acceptance terminal. The payment card may be inserted therein may then receive user input, for example token-based payment credentials, single-use payment credentials or a passcode. In the case of a token, token-based payment credentials may be generated by decoding token information included in the token. Embodiments of the invention provide for the token to be alphanumeric and optionally encrypted and for the payment card to be configured to decrypt the token. Encrypting the token may reduce the human readable length of the token, For example a user may read and subsequently enter a four digit token into the payment card, which when decrypted, may have a greater length. This effectively reduces the length of the token which the user enters into the payment card and my consequently reduce likelihood of errors. Embodiments of the invention accordingly provide a device and system with which and wherein tokens may be used in an interoperable manner with third-parties, being merchants or the like, having a conventional card acceptance terminal and a connection to a payment processing network.

It will be appreciated that although FIGS. 3A and 3B illustrate embodiments wherein the payment card includes an acceptance terminal interface component in the form of a contact-based interface, portions of the description may similarly apply to embodiments wherein the acceptance terminal interface component is provided by a magnetic stripe, a wireless interface component or the like.

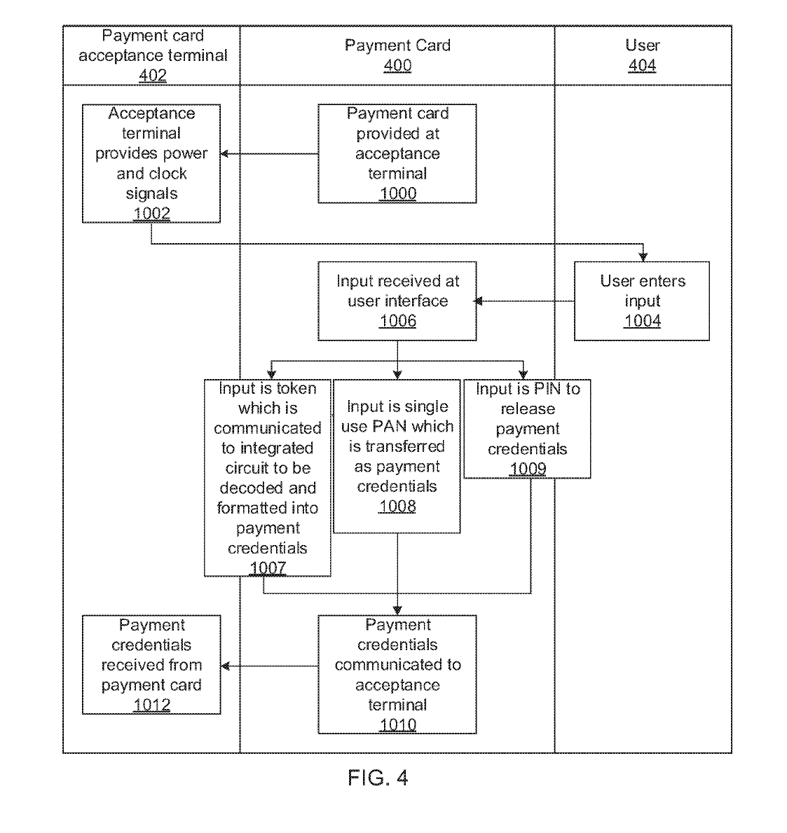

Use of a payment card or dual-interface adapter device of the foregoing description will now be described with reference to FIG. 4, which is a swim-lane flow diagram showing roles of various parties.

In a first step (1000), the payment card (400) is provided at a payment card acceptance terminal. In some embodiments, this may include the payment card (400) being inserted into a payment card acceptance terminal (402) while in other embodiments the payment card (400) may be brought into the vicinity of the payment card acceptance terminal (402) such that the payment card may communicate wirelessly with the card acceptance terminal (402).

When the payment card (400) is provided at a card acceptance terminal (402) the payment card (400), including the user input receiving component and integrated circuit, receives power from the card acceptance terminal (402) in a next step (1002). In some embodiments power is provided from the payment card acceptance terminal (402) to the payment card (400) through the C1 (for VCC) and C5 (for GND) contact pads. The card acceptance terminal (402) may, for example, supply a voltage in the range of 1 V to 6 V to the payment card (400). The user input receiving component draws power from the card acceptance terminal (402) through the physical connection between the payment card (400) and the card acceptance terminal (402) at the C1 and C5 contact pads when the payment card (400) is inserted into the card slot of the card acceptance terminal (402). In another embodiment, the payment card (400) may be configured to harvest power from the card acceptance terminal (402) using, for example, NFC or otherwise harvesting electromagnetic power.

Furthermore, embodiments provide for the card acceptance terminal (402) to provide a clock signal in a range of 1 MHz to 5 MHz to the payment card (400) through the C3 contact pad. The clock signal may be used by the integrated circuit as a reference clock to transmit and receive transaction data, which may include payment credentials, to and from the card acceptance terminal through the C7 contact pad. The transaction data may be arranged in character frames in accordance with the EMV specification.

The payment card (400) is then operable to receive a user input by the user (404) directly into the payment card (400). The user (404) may directly input one of: a token, single-use payment credentials or a passcode. In a next step (1004), the user (404) directly inputs, for example by pressing buttons of the user input receiving component provided with the payment card (400), one of a token, single-use payment credentials or a passcode. In the case of a token, the user (404) may have received the token in message from his or her mobile money provider, received the token from a friend or may have generated the token using his or her mobile device.

The input is received at the user input receiving component of the payment card (400) in a next step (1006).

A following step (1007, 1008, 1009) may take on various forms according to various embodiments. In one embodiment (1007), where a payment token is input into the payment card, the token is communicated to the integrated circuit of the payment card (400) and decoded thereat. The decoded information of the token may then be formatted into payment credentials being, for example, track 2 or track 2 equivalent data for communication to the card acceptance terminal (402).

In another embodiment (1008), wherein single-use payment credentials (or a single-use PAN or account number) are input into the payment card (400), the single-use payment credentials are transferred as payment credentials.

In a further embodiment (1009), wherein a passcode is input into the payment card (400), the passcode is compared to an offset stored in the integrated circuit and, if the passcode match the offset, payment credentials stored in the integrated circuit are released for transmission to the payment card acceptance terminal (402). Comparing the passcode to the passcode offset may include hashing the passcode and comparing the hashed passcode to the stored passcode offset.

In any event, in a next step (1010), the payment credentials (being obtained from a token, being single-use payment credentials, or being payment credentials stored in the payment card) are communicated from the integrated circuit to the card acceptance terminal (402) via the acceptance terminal interface component. In a final step (1012), the payment card acceptance terminal (402) receives the payment credentials from the payment card (400). The card acceptance terminal (402) may then be operable to communicate the payment credentials to a payment processing network so as to complete and/or further process the transaction.

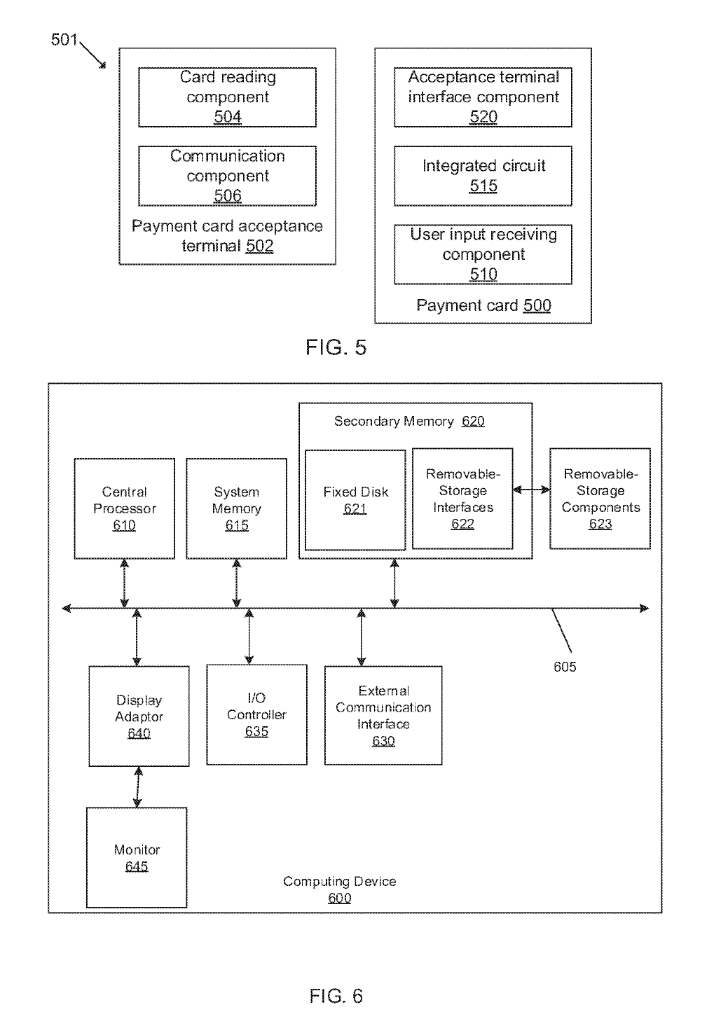

FIG. 5 is a block diagram which illustrates a system (501) for providing payment credentials. The system includes a payment card (500) and a payment card acceptance terminal (502).

The payment card acceptance terminal (502) includes a card reading component (504) for interfacing with the payment card (500). The payment card acceptance terminal may also include a communication component (506) for communicating with a payment processing network.

The payment card (500) may include an acceptance terminal interface component (520) for interfacing with the payment card acceptance terminal (502). The acceptance terminal interface component (502) may be one or more of the group of: a contact-based interface; a wireless interface component (for example an ISO/IEC 14443 wireless communication interface); and a magnetic stripe.

The payment card (500) may also include a user input receiving component (510) for receiving an input by a user directly and an integrated circuit (515) in communication with the acceptance terminal interface (520) and the user input receiving component (510) and configured to provide payment credentials to the payment card acceptance terminal (502) on receipt of an input at the user input receiving component (510).

The integrated circuit (515) may be a secure-cryptoprocessor. In some embodiments, the integrated circuit (515) may be a hardware security module having a public processor and secure processor.

FIG. 6 illustrates an example of a computing device (600) in which various aspects of the disclosure, such as for example a payment card acceptance terminal, may be implemented. The computing device (600) may be suitable for storing and executing computer program code. The various participants and elements in the previously described system diagrams may use any suitable number of subsystems or components of the computing device (600) to facilitate the functions described herein.

The computing device (600) may include subsystems or components interconnected via a communication infrastructure (605) (for example, a communications bus, a cross-over bar device, or a network). The computing device (600) may include at least one central processor (610) and at least one memory component in the form of computer-readable media.

The memory components may include system memory (615), which may include read only memory (ROM) and random access memory (RAM). A basic input/output system (BIOS) may be stored in ROM. System software may be stored in the system memory (615) including operating system software.

The memory components may also include secondary memory (620). The secondary memory (620) may include a fixed disk (621), such as a hard disk drive, and, optionally, one or more removable-storage interfaces (622) for removable-storage components (623).

The removable-storage interfaces (622) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (622) may also be in the form of ports or sockets for interfacing with other forms of removable-storage components (623) such as a flash memory drive, external hard drive, or removable memory chip, etc.

The computing device (600) may include an external communications interface (630) for operation of the computing device (600) in a networked environment enabling transfer of data between multiple computing devices (600). Data transferred via the external communications interface (630) may be in the form of signals, which may be electronic, electromagnetic, optical, radio, or other types of signal.

The external communications interface (630) may enable communication of data between the computing device (600) and other computing devices including servers and external storage facilities. Web services may be accessible by the computing device (600) via the communications interface (630).

The external communications interface (630) may also enable other forms of communication to and from the computing device (600) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (610).

A computer program product may be provided by a non-transient computer-readable medium, or may be provided via a signal or other transient means via the communications interface (630).

Interconnection via the communication infrastructure (605) allows a central processor (610) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (600) either directly or via an I/O controller (635). These components may be connected to the computing device (600) by any number of means known in the art, such as a serial port.

One or more monitors (645) may be coupled via a display or video adapter (640) to the computing device (600).

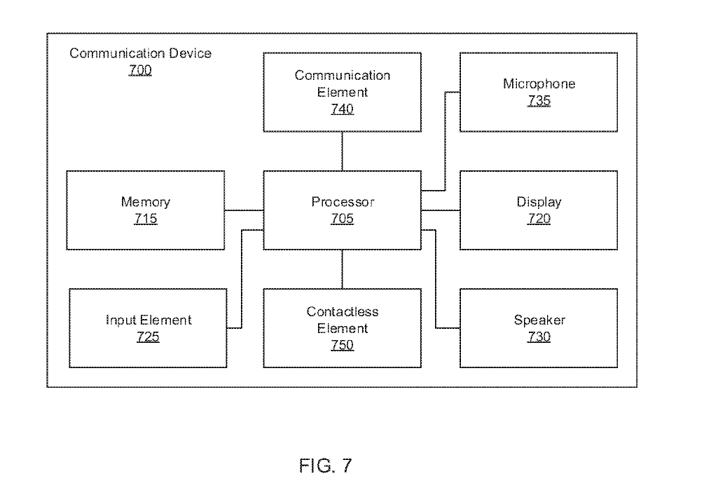

FIG. 7 shows a block diagram of a communication device (700) that may be used in embodiments of the disclosure, such as for example as a payment card acceptance terminal. The communication device (700) may be a mobile phone, a cell phone, a feature phone, a smart phone, a satellite phone, or a computing device having a phone capability.

The communication device (700) may include a processor (705) (e.g., a microprocessor) for processing the functions of the communication device (700) and a display (720) to allow a user to see the phone numbers and other information and messages. The communication device (700) may further include an input element (725) to allow a user to input information into the device (e.g., input buttons, touch screen, etc.), a speaker (730) to allow the user to hear voice communication, music, etc., and a microphone (735) to allow the user to transmit his or her voice through the communication device (700).

The processor (710) of the communication device (700) may connect to a memory (715). The memory (715) may be in the form of a computer-readable medium that stores data and, optionally, computer-executable instructions.

The communication device (700) may also include a communication element (740) for connection to communication channels (e.g., a cellular telephone network, data transmission network, Wi-Fi network, satellite-phone network, Internet network, Satellite Internet Network, etc.). The communication element (740) may include an associated wireless transfer element, such as an antenna.

The communication element (740) may include a subscriber identity module (SIM) in the form of an integrated circuit that stores an international mobile subscriber identity and the related key used to identify and authenticate a subscriber using the communication device (700). One or more subscriber identity modules may be removable from the communication device (700) or embedded in the communication device (700).

The communication device (700) may further include a contactless element (750), which is typically implemented in the form of a semiconductor chip (or other data storage element) with an associated wireless transfer element, such as an antenna. The contactless element (750) may be associated with (e.g., embedded within) the communication device (700) and data or control instructions transmitted via a cellular network may be applied to the contactless element (750) by means of a contactless element interface (not shown). The contactless element interface may function to permit the exchange of data and/or control instructions between mobile device circuitry (and hence the cellular network) and the contactless element (750).

The contactless element (750) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (700) and an interrogation device. Thus, the communication device (700) may be capable of communicating and transferring data and/or control instructions via both a cellular network and near field communications capability.

The data stored in the memory (715) may include: operation data relating to the operation of the communication device (700), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (700) to selected receivers.

The communication device (700) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed, Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network,

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A payment card for use with a payment card acceptance terminal, the payment card comprising:
an acceptance terminal interface component for interfacing with a payment card acceptance terminal;
a user input receiving component for receiving an input by a user directly;
an integrated circuit in communication with the acceptance terminal interface component and the user input receiving component and configured to provide payment credentials to the payment card acceptance terminal on receipt of an input at the user input receiving component.

2. The payment card as claimed in claim 1, wherein the integrated circuit is configured to provide payment credentials stored on the payment card on receipt of an input in the form of a passcode at the user input receiving component.

3. The payment card as claimed in claim 1, wherein the integrated circuit is configured to provide payment credentials in the form of a single use account number received as an input at the user input receiving component.

4. The payment card as claimed in claim 1, wherein the integrated circuit is configured to provide payment credentials formatted by the integrated circuit by transforming an input in the form of a token received at the user input receiving component into the payment credentials.

5. The payment card as claimed in claim 4, wherein the integrated circuit is configured to decode the token and to appropriately format information contained therein into payment credentials, wherein the information contained in the decoded token includes an account number.

6. The payment card as claimed in claim 5, wherein the integrated circuit is configured to include a bank identification number in the payment credentials, wherein the bank identification number is retrieved from a digital memory of the integrated circuit.

7. The payment card as claimed in claim 6, wherein the integrated circuit is configured to generate a card verification value, wherein generating a card verification value encrypts one or more of a primary account number, expiration date and service code using an encryption key and decimalizes the result; and wherein the encryption key is retrieved from a digital memory of the integrated circuit.

8. The payment card as claimed in claim 1, wherein the user input receiving component is a keypad integrated into the payment card.

9. The payment card as claimed in claim 1, wherein the acceptance terminal interface component is a contact-based interface insertable into a card slot of the acceptance terminal; Wherein the contact-based interface includes conductive contact pads for providing a contact based connection to corresponding conductive contacts of the card slot of the payment card acceptance terminal.

10. The payment card as claimed in claim 1, wherein the acceptance terminal interface component is a wireless interface component for communicating wirelessly with the payment card acceptance terminal.

11. The payment card as claimed in claim 1, wherein the acceptance terminal interface component is a magnetic stripe.

12. The payment card as claimed in claim 1, wherein the user input receiving component is configured to receive or harvest power from the card acceptance terminal.

13. The payment card as claimed in claim 1, wherein the integrated circuit is a secure crypto-processor configured to perform cryptographic functions and translation functions.

14. The payment card as claimed in claim 13, wherein the secure crypto-processor enables end-to-end secure communications between the user input receiving component and the acceptance terminal interface component.

15. The payment card as claimed in claim I, wherein the integrated circuit is a hardware security module comprising a public processor and a secure processor.

16. A system for providing payment credentials, comprising:
a payment card acceptance terminal having a card reading component; and
a payment card for use with the payment card acceptance terminal including:
an acceptance terminal interface component for interfacing with a payment card acceptance terminal;
a user input receiving component for receiving an input by a user directly; and
an integrated circuit in communication with the acceptance terminal interface component and the user input receiving component and configured to provide payment credentials to the payment card acceptance terminal on receipt of an input at the user input receiving component.

17. A method carried out at an integrated circuit of a payment card comprising:
receiving a user input, wherein the user input is directly received into the payment card;
providing payment credentials to an acceptance terminal interface component based on the user input.

18. The method as claimed in claim 17, wherein receiving a user input receives a passcode and providing payment credentials releases stored payment credentials from the payment card to the acceptance terminal interface component.

19. The method as claimed in claim 17, wherein receiving a user input receives a single use account number and providing payment credentials provides the single use account number to the acceptance terminal interface component.

20. The method as claimed in claim 17, wherein receiving a user input receives a token and providing payment credentials transforms the user input into formatted payment credentials.
